(19) United States
(12) Patent Application Publication
(10) Pub. No.: US 2022/0015143 A1
(43) Pub. Date: Jan. 13, 2022

(54) RELAY OPERATIONS IN A COMMUNICATION SYSTEM

(71) Applicant: Nokia Technologies Oy, Espoo (FI)

(72) Inventors: Esa Tapani TIIROLA, Kampele (FI); Kari Juhani HOOLI, Oulu (FI); Timo KOSKELA, Oulu (FI); Sami-Jukka HAKOLA, Kempele (FI)

(21) Appl. No.: 17/413,693

(22) PCT Filed: Dec. 20, 2018
(86) PCT No.: PCT/EP2018/086158

§ 371 Date: Jun. 14, 2021

(51) Int. Cl. H04W 74/08; H04L 5/00; H04W 72/12; H04W 72/04

(52) U.S. Cl. CPC H04W 74/0808; H04L 5/0048; H04B 7/15542; H04W 72/0446; H04W 72/1252

(57) ABSTRACT

A method comprising: determining a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category; determining if link category for transmission is the first or the second link category; determining if the channel is available for the transmission according to a pattern associated with the determined link category, wherein the pattern associated with the determined link category corresponds to the first or the second pattern; and if the channel is available, acquiring the channel and transmit according to the pattern associated with the determined link category.

### FIELD

The following embodiments relate to relay operations in a communication system that help to extend coverage of the communication system.

### BACKGROUND

It is beneficial to have network functionality available as widely as possible. Therefore, network coverage is an important issue and having as wide network coverage as possible may be beneficial. Various methods of increasing network coverage are therefore of interest.

### BRIEF DESCRIPTION OF THE INVENTION

According to an aspect, there is provided a method comprising: determining a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category; determining if link category for transmission is the first or the second link category; determining if the channel is available for the transmission according to a pattern associated with the determined link category, wherein the pattern associated with the determined link category corresponds to the first or the second pattern; and if the channel is available, acquiring the channel and transmit according to the pattern associated with the determined link category.

According to another aspect, there is provided an apparatus, comprising: at least one processor, and at least one memory including a computer program code, wherein the at least one memory and the computer program code are configured, with the at least one processor, to cause the apparatus to: determine a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category; determine if link category for transmission is the first or the second link category; determine if the channel is available for the transmission according to a pattern associated with the determined link category, wherein the pattern associated with the determined link category corresponds to the first or the second pattern; and if the channel is available, acquire the channel and transmit according to the pattern associated with the determined link category.

According to another aspect there is provided an apparatus comprising means for determining a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category; means for determining if link category for transmission is the first or the second link category; means for determining if the channel is available for the transmission according to a pattern associated with the determined link category, wherein the pattern associated with the determined link category corresponds to the first or the second pattern; and if the channel is available, means for acquiring the channel and means for transmitting according to the pattern associated with the determined link category.

According to another aspect there is provided a computer program product readable by a computer and, when executed by the computer, configured to cause the computer to execute a computer process comprising: determining a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category; determining if link category for transmission is the first or the second link category; determining if the channel is available for the transmission according to a pattern associated with the determined link category, wherein the pattern associated with the determined link category corresponds to the first or the second pattern; and if the channel is available, acquiring the channel and transmit according to the pattern associated with the determined link category.

### LIST OF DRAWINGS

In the following, the invention will be described in greater detail with reference to the embodiments and the accompanying drawings, in which

FIG. 1 illustrates an example embodiment of a communication system.

FIGS. 2a-2c illustrate example embodiments of allocating resources within a communication system.

FIGS. 3a and 3b illustrate examples of cross-link interference.

FIGS. 4a-4e illustrate various links that are to be supported by time domain resources.

FIGS. 5 and 6 illustrate example embodiments of a multi-hop scenario.

FIGS. 7 and 8 are flow charts illustrating example embodiments.

FIG. 9 illustrates an example embodiments of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

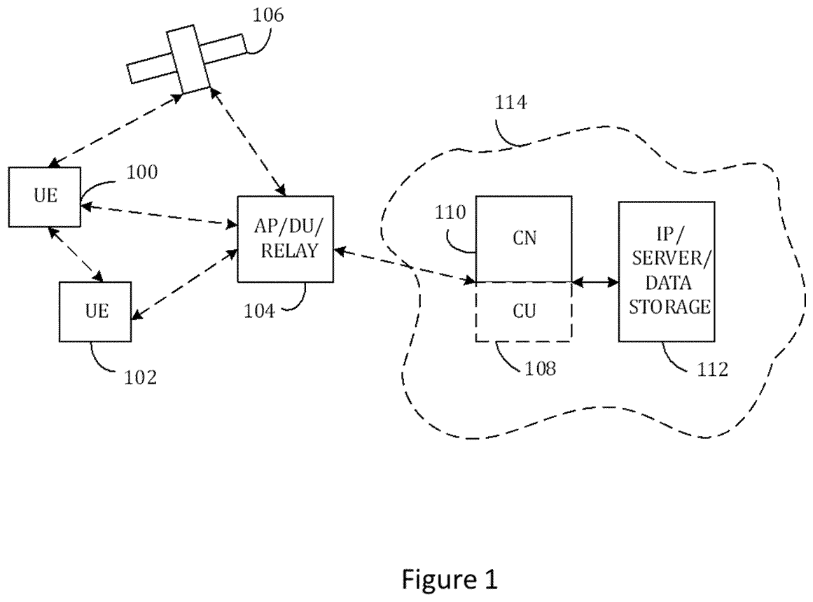

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The physical link from a terminal device to a (e/g)NodeB is called uplink or reverse link and the physical link from the (e/g)NodeB to the terminal device is called downlink or forward link. It should be appreciated that (e/g)NodeBs or their functionalities may be implemented by using any node, host, server or access point etc. entity suitable for such a usage.

A communication system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of terminal devices (UEs) to external packet data networks, or mobile management entity (MME), etc.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (central unit) may coordinate the DU operation via F1AP-interface for example.

The terminal device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a central unit, CU 108).

It should also be understood that the distribution of labour between core network operations and base station operations may differ from that of the LTE or even be non-existent. Some other technology probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is to be noted that the depicted system is only an example of a part of a radio access system and in practice, the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home(e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

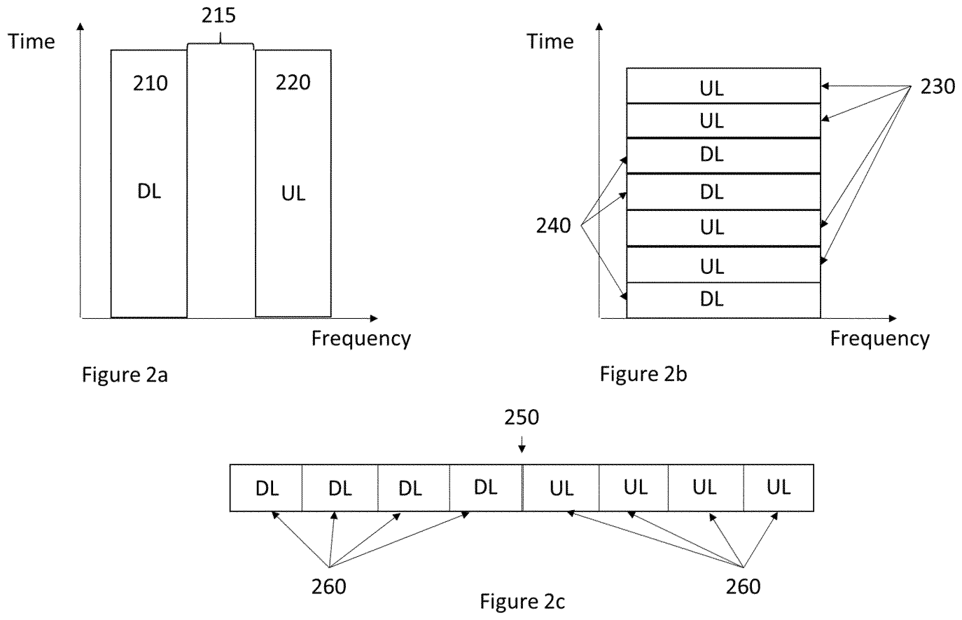

In a communication system the communication between a terminal device and an access node may be configured to happen such that uplink communication is allocated a certain frequency band to be used while the downlink has a different frequency band allocated to its communication. This is illustrated in FIG. 2a. Because of the different frequency bands allocated to downlink (210) and uplink (220), downlink (210) and uplink (220) transmissions may happen simultaneously. This model is called frequency division duplexing, FDD. Transmission may be understood as transmittance of one or more data package between a terminal device and an access node. Transmission direction may be uplink or downlink direction. The downlink (210) and uplink (220) frequency bands may be separated by a frequency offset (215). As the downlink (210) and uplink (220) have separate frequency bands, transmissions in uplink and downlink directions do not interfere each other.

Another approach is technology called time division duplex, TDD, introduced in FIG. 2b. In this technology, uplink (230) and downlink (240) are using the same frequency band but are separated by time slots for using the frequency band allocated to them. In other words, while the frequency band is the same for uplink (230) and downlink (240) transmissions, they do not use the frequency band for transmissions simultaneously but are allocated separate time slots for using the frequency band. TDD thereby emulates full duplex communication over a half-duplex communication link. An advantage of TDD is that it may adapt well to a situation in which the data rates of uplink (230) and downlink (240) are asymmetrical. For example, if the amount of data to be transmitted in uplink (230) direction increases, more communication capacity may easily be allocated by dynamically allocating more time slots for uplink (230) transmission. Correspondingly, if the amount of data to be transmitted in the uplink (240) direction reduces, communication capacity may be freed from the uplink (240) transmission and allocated to downlink (240) transmission. The same applies when the amount of data to be transmitted in downlink (240) direction increases or decreases. Although not explicitly illustrated in FIG. 2b, it is to be noted that it is possible to have guard period time slots between adjacent time slots. This may be advantageous if the adjacent time slots are allocated such that the transmission direction changes from uplink (230) to downlink (240) or vice versa. It is to be noted that the time slot allocations illustrated in FIG. 2b are for illustrating purpose only. As the uplink (230) and downlink (240) transmissions take place in the same frequency band, TDD is suitable to be used in an unpaired spectrum which can be understood as spectrum that is allocated by the regulators as one block that is to be used for both uplink (230) and downlink (240).

To support the bi-directional communication, the time domain resources need to be allocated. FIG. 2c illustrates an example partitioning of the time domain resources (250). The partitioning may also be known as a frame structure or it may also be known as channel occupancy time, COT, structure and it may be understood as a timing structure that supports bi-directional communication. The partitioning of the time domain resources may have a fixed overall duration or the overall duration may vary. Within the time domain resource partitioning (250), there can be slots (260) that each have a fixed duration. The slots (260) have been allocated to uplink and downlink communication. The time domain resource partitioning (250), which may be understood as the allocation of the slots (260), to be used may be determined by an access node. It is to be noted that although slots are referred to above, in some example embodiments there may be portions of the slot or mini-slots that are used in the time domain resource partitioning to allocate resources. It is to be noted that a portion (260) may in some example embodiments comprise one orthogonal frequency division multiplexing, OFDM, symbol while in some other example embodiments the portion (260) may correspond to a mini-slot, which may comprise e.g. 7, 4 or 2 OFDM symbols for example. In yet some other example embodiments, the portion (260) may correspond to a slot that may comprise 14 OFDM symbols. In a cellular communication system, the time domain resource partitioning used by each access node may be the same thereby causing the same time domain resource partitioning to be used in all cells. In some example embodiments, the time domain resource partitioning to be used is fixed and may be modified only in maintenance. In some alternative examples the time domain resource partitioning may be modified dynamically by the access node. Dynamic modification of the time domain resource partitioning in a cellular communication system may cause adjacent cells to use time domain resource partitionings that are structured differently from each other.

It is to be noted that TDD technology may be used not only in a cellular communication system but also in other communication systems such as wired, optical or acoustic communication systems.

If the time domain resource partitioning is dynamically modified, the transmission direction may be changed between uplink and downlink efficiently and thereby improve utilization of physical resources both in time and frequency domain. This may result in higher throughput and reduced latencies.

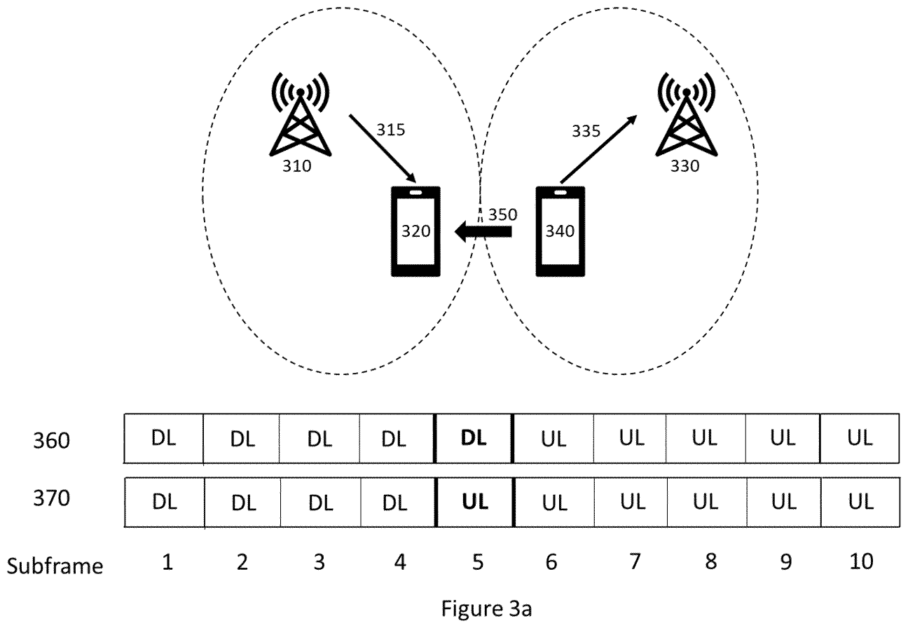

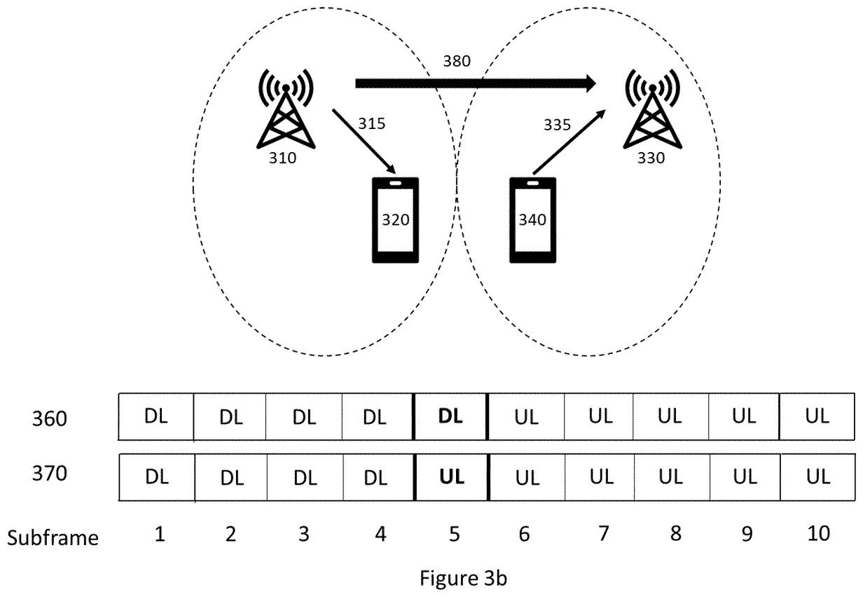

If adjacent cells have different time domain resource partitionings, probability of cross-link interference occurring increases. FIG. 3a illustrates cross-link interference that may occur between terminal devices. An access node (310) provides a cell within which a terminal device (320) is located. The terminal device (310) is however located close to the edge of the cell. An access node (330) provides another cell that is a neighbor cell to that provided by the access node (310). Terminal device (340) is located within the cell provided by the access node (330) such that it is close to the edge of the cell and adjacent to the terminal device (320). The cell provided by the access node (310) uses, in this example embodiment, a time domain resource partitioning (360) in which the first five slots are allocated to downlink transmission (315) and the rest of the slots are allocated to uplink transmission. The cell provided by the access node (330) on the other hand uses a time domain resource partitioning (370) in which the first four slots are allocated to downlink transmission and the rest of the slots, slots 5-10, are allocated to uplink transmission (335).

Because the time domain resource partitionings (360) and (370) are different, the slot 5 is allocated in the time domain resource partitioning (360) to downlink direction (315) but in the time domain resource partitioning (370) the slot 5 is allocated to uplink direction (335). As the frequency band used is the same for the terminal device (320) and the terminal device (340) and they are physically located close to each other, the simultaneous transmission to opposite directions using the same frequency band may cause interference called cross-link interference. If the terminal device (330) transmits a data packet in uplink direction (335) using the same frequency domain resources that are simultaneously used by the terminal device (320) to receive a data packet in downlink direction (315), it is possible that the packet received by the terminal device (320) cannot be successfully decoded due to an interference level. This cross-link interference (350) occurs between the terminal devices (320) and (340) and the closer the terminal devices are to each other while still being served by different access nodes, the higher the probability of the cross-link interference (350) occurring.

FIG. 3a illustrated an example embodiment in which the cross-link interference occurred between terminal devices. FIG. 3b illustrates another example embodiment in which cross-link interference occurs between two access nodes instead of two terminal devices. Like in FIG. 3a, the access node (310) provides a cell within which the terminal device (320) is located. The time domain resource partitioning (360) is used by the access node (310). The access node (330) provides the cell in which the terminal device (340) is located and the time domain resource partitioning (370) is used by the access node (330). Therefore, during the slot five the access node (310) transmits a data packet to the terminal device (320) in the downlink direction (315). At the same time, using the same frequency band, the access node (330) receives in the uplink direction (335) a data packet from the terminal device (340). The data packet transmitted by the access node (310) may provide interference for the access node (330) in receiving of the data packet transmitted by the terminal device (340). This cross-link interference (380) thereby occurs between the access nodes (310) and (330).

For the purpose of achieving high-speed broadband communication, millimetre wave may be utilized. It is to be noted that also other frequency bands, such as unlicensed band at 5 GHz could be used. Millimetre waves have short wavelengths that range from 10 millimeters to 1 millimeter. Millimeter wave, mmWave, spectrum is the frequency band between 30 GHz and 300 GHz. It may also be possible to use technologies defined for mmWave also below 30 GHz. For example, 28 GHz could be used. Some sub-bands of the mmWave frequency band may require a license from the regulators while other sub-bands may be unlicensed and thereby available without a license. Due to the wide frequency spectrum available and the high data speeds enabled, the mmWave is currently foreseen as a promising bandwidth to be used for 5G communication systems. Yet the short wavelength of mmWave causes high attenuation and the waves may be absorbed by gases in the atmosphere as well as attenuated by buildings and other obstacles in the environment.

Because of the high attenuation, the cell coverage achieved by one access node operating in the mmWave bandwidth is relatively small when comparing to the cell coverage of a 4G access node operating on a lower frequency band for example. In some examples, massive MIMO may be used as means to compensate the increased propagation loss. It is to be noted that regulatory rules may set a power spectral density limit which may limit the possibilities for improving the cell coverage by means of beamforming. This may be situation for example with regard to using an unlicensed band. Due to the relatively small cell coverage achieved by an access node, there may be a need for having more access nodes to cover a geographical area. It may be that not all such access nodes are equipped with a wired backhaul connection. If an access node does not have a wired backhaul connection, the access node may utilize the wireless channel resources to connect to an access node that does have a wired backhaul connection or the access node may connect to another access node and the other access node is then connected to an access node with a wired backhaul connection. The access node may therefore be called as an integrated access and backhaul, IAB, node. The access node that does have the wired backhaul connection and to which the IAB node connects to for backhauling, may be called as a donor node. In the case of self-backhaul (a.k.a. integrated access and backhaul) the donor node uses the same wireless channel to serve terminal devices that are within a cell provided by the donor access node and to provide a wireless backhaul connection for the IAB node. Out-of-band relaying corresponds to a scenario without access terminal devices in a spectrum where the out-of-band relaying takes place. In some examples, a donor node may also have out-of-band relayed backhaul connection instead of a wired backhaul connection.

By having donor nodes and IAB nodes, the coverage of a communication system may be extended without having to equip all access nodes with a wired backhaul connection. This may be useful if the communication system operates using an unlicensed frequency band, like at or around 60 GHz for example. As the donor node (and/or CU) is configured to have an overall control of the radio resources, coverage extension may be achieved with minimal manual efforts and self-configuration of the communication system may be enabled.

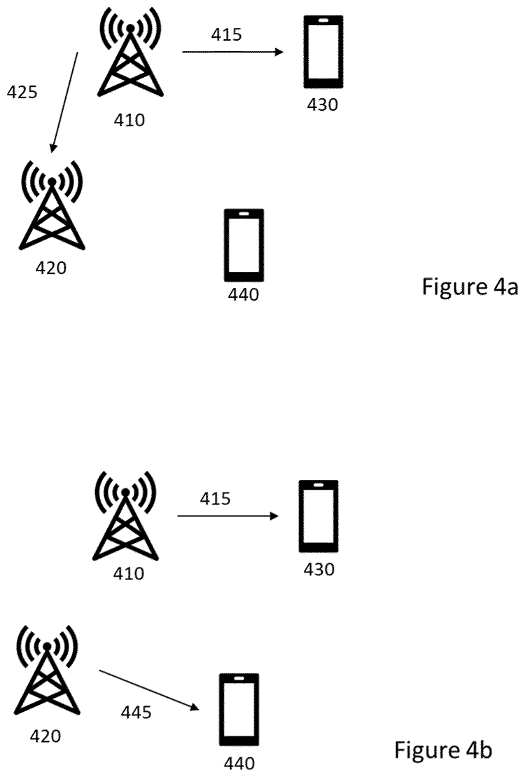

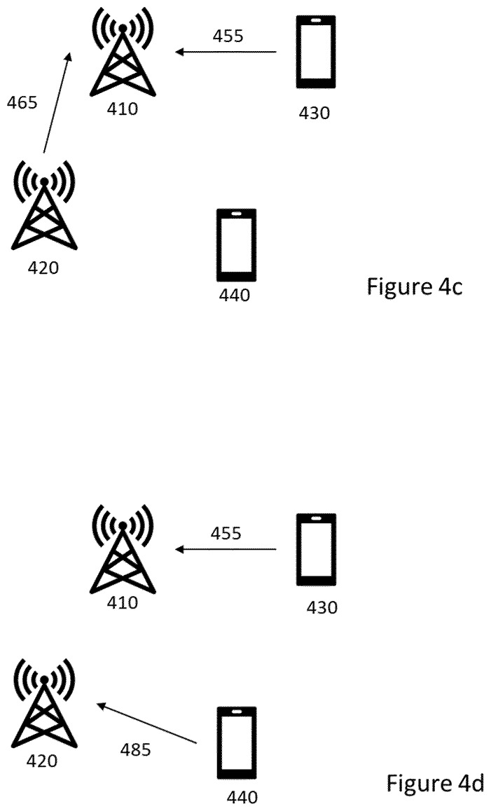

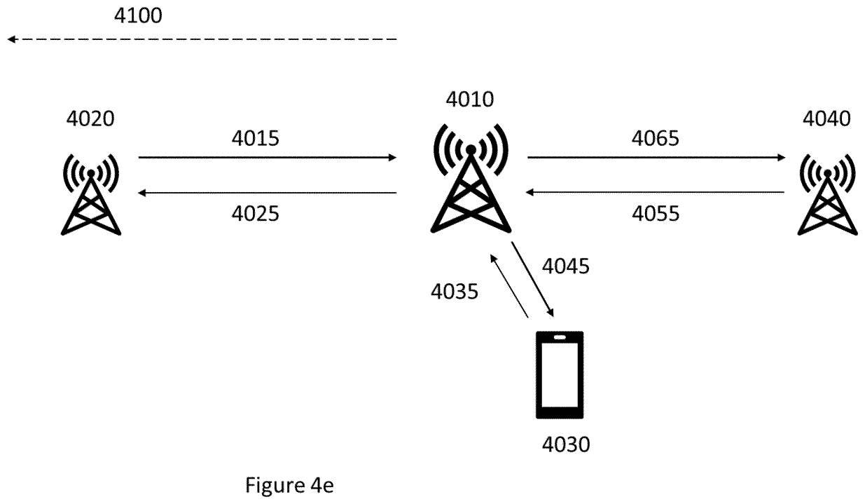

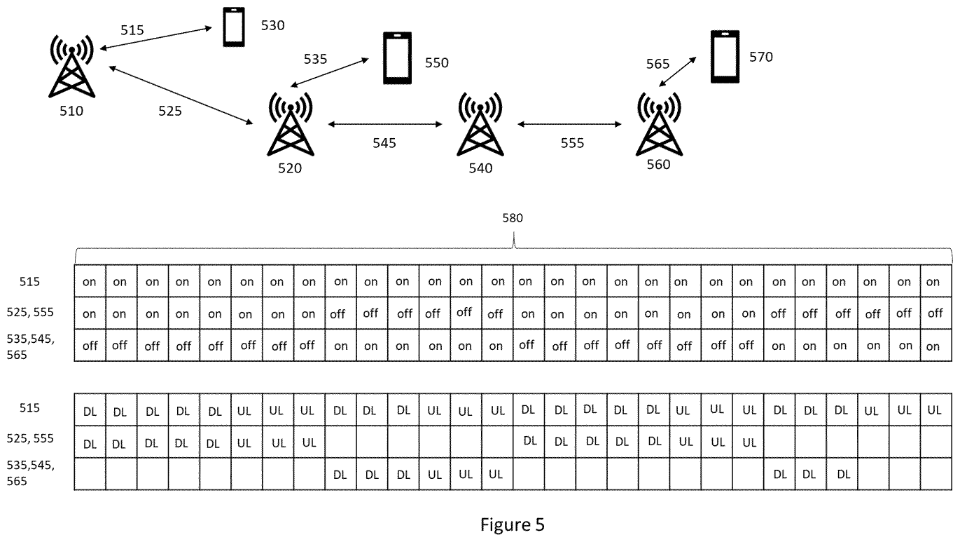

FIGS. 4a-4d illustrate how IAB node (420) may communicate with a donor node (410) and a terminal device (440) when operating under TDD half-duplex constraint. It is to be noted that while in this example embodiment the donor node (410) is illustrated serving only one IAB node (420), in some other example embodiments there could be multiple IAB nodes the donor node (410) serves. In this example embodiment the donor node (410) also serves a terminal device (430), but in some other example embodiments, the donor node (410) could serve multiple terminal devices. Likewise, the IAB node (420) serves in this example embodiment only the terminal device (440), but in some other example embodiments, the IAB node (420) could serve multiple terminal devices and/or one or more access nodes.

Four separate time domain resources are to be available in the example embodiment illustrated by FIGS. 4a-4d. FIG. 4a illustrates the backhaul downlink phase, FIG. 4b illustrates the access downlink phase, FIG. 4c illustrates the backhaul uplink phase and FIG. 4d illustrates the access uplink phase. In the phase of FIG. 4a, the donor node (410) transmits downlink data/control (415) to the terminal device (430) and downlink data/control (425) to the IAB node (420). In the phase of FIG. 4b, the donor node (410) continues to transmit downlink data/control (415) to the terminal device (430) but does not transmit downlink data/control to the IAB node (420). Instead the IAB node (420) transmits downlink data/control (445) to the terminal device (440). As can be seen from the FIGS. 4a and 4b, the transmitting phases of the access nodes, the donor node (410) and the IAB node (420), are to be co-ordinated. The receiving phases of the access nodes, the donor node (410) and the IAB node (420), are to be co-ordinated as well as can be seen from FIGS. 4c and 4d. In FIG. 4c, the donor node (410) receives uplink/control data (455) from the terminal device (430) and uplink data/control (465) from the IAB node (420). In FIG. 4d the donor access node (410) continues to receive uplink data/control (455) from the terminal device (430) but no longer receives uplink data/control from the IAB node (420). Instead, the IAB node (420) receives uplink data/control (485) from the terminal device (440). Co-ordination of the transmitting and receiving phases of the access nodes enables the IAB node (420) to listen to scheduling information from the donor node (410). Also, the co-ordination enables the donor node (410) to listen to scheduling request information from the IAB node (420).

FIG. 4e illustrates an example embodiment of IAB nodes and links between IAB nodes and access terminal devices that are terminal devices having access links to the IAB node. In the FIG. 4e there is a backhaul downlink (4015) and a backhaul uplink (4025) between and IAB node (4010) and a parent node (4020) which may be another IAB node. The parent node (4020) provides backhaul links to the IAB node (4010) but, in some example embodiments, it may not have a wired backhaul connection itself. Arrow (4100) illustrates the direction towards a donor node having a wired backhaul connection. Transmissions between the parent node (4020) and the IAB node (4010) may be scheduled by the parent node (4020). Therefore, the link (4015) may also be called as parent backhaul downlink and the link (4025) may also be called as parent backhaul uplink.

In FIG. 4e there is also link (4065) which is a backhaul downlink and link (4055) which is a backhaul uplink between the IAB node (4010) and another IAB node, that is a child node, (4040). The IAB node (4010) schedules transmission between the IAB node (4010) and the child node (4040). Therefore, the link (4065) may also be called as child backhaul downlink and the link (4055) may also be called as child backhaul uplink. Links (4055) and (4065) may also be called as child links.

In FIG. 4e there is further link (4045) which is an access downlink and link (4035) which is an access uplink between the IAB node (4010) and a terminal device (4030). The IAB node (4010) schedules transmission between the IAB node (4010) and the terminal device (4030). Therefore, the link (4045) may also be called as child access downlink and the link (4035) may also be called as child access uplink. Links (4035) and (4045) may also be called as child links.

The IAB node (4010) comprises a mobile terminal, MT, functionality that facilitates reception of parent backhaul downlink and transmission of parent backhaul uplink. The IAB node (4010) further comprises distributed unit, DU, functionality which is separate from the MT functionality. The DU functionality facilitates e.g. transmission of child backhaul downlink and access link and reception of child backhaul uplink and access link.

The link (4015) is facilitated by downlink time resources and the link (4025) is facilitated by uplink time resources. In some example embodiments, there may further be flexible time resources that facilitate dynamic capacity allocation between downlink and uplink and between parent backhaul links and child links.

In the example embodiment of FIG. 4e, the child links may have the following resources available: downlink time, uplink time, flexible time and not available time. The not available time resource is not to be used for communication on the DU child links. The time resources available for the child links may be categorized as hard or soft. Hard resources are such that corresponding time resource is always available for the DU child link and soft resources are such that availability of the corresponding time resource for the DU child link is explicitly and/or implicitly controlled by the parent node. In some example embodiments, flexible resources from MT point of view may be seen as soft resources from DU point of view.

In some example embodiments, the IAB node (4010) operates according to centralized co-ordination. Yet in some other example embodiments, the IAB node (4010) operates according to a distributed co-ordination. In the distributed co-ordination the parent node (4020) is responsible for downlink and uplink scheduling for the parent links using the resources available. The parent node (4020) is also responsible for dynamic adaptation of available resources between parent and child links. In some example embodiments this is based on flexible and/or soft resources.

In some example embodiments, a CU may determine a semi-static resource configuration separately for each IAB node. One resource configuration may then cover both MT and DU parts of the IAB node. Alternatively, separate resource configuration is provided for MT and DU parts of the IAB node. It may also be possible for available resources to further comprise additional resource types. The parent node then allocates the available soft resources in the parent backhaul links to facilitate dynamic resource allocation between downlink and uplinks and also between parent and child links.

In order to detect when to start transmitting data, on the other hand, a concept called “listen before talk”, LBT, may be utilized. In an example embodiment of the LBT, type 1 LBT, an access node may generate a random number N uniformly distributed over a contention window. Once the access node has measured the channel to be vacant for N times or occasions, it may occupy (access) the channel with transmission. In another example embodiment of the LBT, type 2 LBT, an access node performs a single channel measurement in time interval, of 25 us for example, before occupying (accessing) the channel with transmission. Yet, the usage of LBT may cause uncertainty regarding the starting time for channel occupancy time, COT, which may conflict with the co-ordination of the transmitting and receiving phases of the access nodes. COT may be defined as a time interval when the device occupies the channel, or as a period that device reserves for transmissions. In some literature, transmission opportunity, TXOP, may be used for the same purpose. The duration of COT is bound to be equal or less than a maximum channel occupancy time. The maximum channel occupancy time may be predetermined by regulations or in system specifications. The device initiating the COT may share the COT with other device or devices. In other words, COT may contain transmissions from the device initiating the COT as well as transmissions sent to the initiating device from other devices. Within the COT there may be one or multiple switching points for the transmission directions controlled by the initiating device. A time domain resources partitioning may be done according to the maximum channel occupancy time.

In some example embodiments type 1 LBT may further comprise not performing LBT at all. For example, if a gap between downlink reception and uplink transmission is smaller than a threshold such as 16 microseconds, LBT may not need to be performed. Also, in an example of gNB acquired COT and there are multiple switching points, no LBT may not be needed for if a gap between uplink reception and downlink transmission is smaller than a threshold such as 16 microseconds. The second type of LBT may be performed between uplink reception and downlink transmission if the gap is more than a threshold such as 16 microseconds.

It is to be noted that LBT framework may, in some example embodiments, be based on regulatory rules. The regulatory rules may be defined for frame-based equipment (FBE) or they may be defined for load based equipment (LBE).

As the network coverage may need to be extended, multi-hop routing may be utilized to extend the coverage. A hop may be understood as an intermediate step between the source of a transmission and the destination of the transmission. In a single-hop network the destination is the only step after the source and thereby the only hop in the communication system. On the other hand, there may be one or more additional hops, for example access nodes acting as relay nodes thereby creating multiple hops.

In FIG. 5 an example of extending coverage of a communication system using multi-hop communication is illustrated. In this example embodiment, the communication system operates in an unlicensed frequency band and utilizes TDD. An access node (510) in this example embodiment is a donor node that has a wired backhaul connection. The access node (510) in this example embodiment is further a gNodeB. In this example embodiment, the donor node (a.k.a. donor gNB) (510) controls a time domain resource partitioning of the multi-hop communication system and thereby also acts as a scheduling node. The donor node (510) serves a terminal device (530) and link (515) exists between the donor node (510) and the terminal device (530). The donor node (510) also serves an access node (520) which is an IAB node that in the multi-hop scenario also schedules resources thereby acting also as a scheduling node. The scheduling node (520) serves the terminal device (550) and the link (535) exists between them. The scheduling node (520) also serves another access node (540) and the link (545) exists between them. The access node (540) is also an IAB node that in the multi-hop scenario also schedules resources thereby acting also as a scheduling node. The scheduling node (540) also serves another access node (560) and the link (555) exists between them. The access node (560) is an IAB node that in the multi-hop scenario also schedules resources thereby acting also as a scheduling node and serves a terminal device (570) and the link (565) exits between them.

The scheduling nodes (510-560) are in this example embodiment configured with two predefined patterns for time domain resource partitioning (580). The patterns are defined to address the multi-hop scenario such that a first pattern defines resource usage for odd numbered hops that are in this example embodiment the links (525) and (555) and a second pattern defines resource usage for even numbered hops that are in this example embodiment the links (535), (545) and (565). The odd numbered hops may be considered to be links of a first category and the even numbered hops may be considered to be links of a second category. The first and the second pattern comprise portions that define resource available for uplink or downlink transmission in the corresponding links. Consecutive portions available for a pattern compose a block of portions. In some alternative examples, slots or mini-slots could be used as well to define resources available for transmission. The time domain resource partitioning is defined by the first and the second pattern such that the odd numbered hops and the even numbered hops do not have resources available simultaneously thereby following the constrains of half-duplex characteristics of time-division multiplexing, TDM. Due to the scheduling introduced by the first and the second pattern, a scheduling node does not have to be prepared for backhaul communication while transmission is active for its access link. FIG. 5 illustrates how the even and odd numbered hops are not “on” simultaneously, meaning that the resources are not available simultaneously.

In some example embodiments, the DU functionality of the IAB node may determine that resources denoted as “off” for the child links cannot be as used schedulable resources for the child links. Additionally, or alternatively, the MT functionality of the IAB node may determine “off” resources as flexible resources not used or scheduled for a parent backhaul link by a serving DU or donor gNB.

In some example embodiments, the DU functionality of the IAB node may determine that resources denoted as “on” can be used as scheduled schedulable resources for the child links. Additionally, or alternatively, the MT functionality of the IAB node may determine “on” resources as resources available for parent backhaul link according to scheduling by a serving IAB node/donor gNB.

In order to follow the LBT scenario, each scheduling node (510-560), in this example embodiment, performs a type 1 LBT before acquiring a channel and initiating downlink transmission. It is to be noted that due to the LBT, the starting time of a COT depends on the success of the performed LBT. Hence time interval between the starting times of consecutive COTs (of the same link and link direction) may vary. The ending of the COT depends on the scheduling determined by the scheduling node provided that the maximum COT allocation or the end of corresponding block of portions is not violated. In this example embodiment, each scheduling node (510-560) is responsible for the resource allocation between uplink and downlink transmission during its COT while the donor node (510) remains responsible for the overall time domain resource partitioning.

In some example embodiments, a COT begins with one or more portions available for downlink transmission (DL) as is illustrated in the time domain resource partitioning (580) of FIG. 5. Alternatively, the COT may begin with one or more portions available for uplink transmission (UL). The scheduling node may send resource allocation information indicating that the COT beings with one or more portions available for uplink transmission using a group common physical downlink control channel, GC-PDCCH. In an example in which it is not known if the COT begins with one or more portions available for uplink or downlink transmission, the receiving party, a terminal device or an access node, may begin in parallel reception of physical downlink shared channel, PDSCH and LBT (based on energy detection for example) while processing the resource allocation information received from the GC-PDCCH. In case the COT does not start with one or more portions available for downlink transmission, the LBT necessary for the uplink transmission is thereby already initiated. As the COT is started with uplink transmission, it is necessary to perform type 1 LBT before the uplink transmission.

In some examples, the COT may begin with one or more portions allocated to downlink transmission, but the scheduling node does not have data for downlink transmission. In such an example, the portion(s) available for downlink transmission are kept to minimal thereby maximising the amount of resources available for the uplink transmission. In some example embodiments, the scheduling node indicates the duration of the one or more portions allocated to downlink transmission and the duration of the one or more portions allocated to uplink transmission using a group common physical downlink control channel, GC-PDCCH.

In some examples it is possible to utilize higher layer signalling to indicate a split between portions available for downlink (DL) and uplink (UL) transmission. An advantage that may be achieved is reduction in cross-link interference. If this approach is to be used, each scheduling node (510-560) is to follow the splits between portions available for downlink (DL) and uplink (UL) transmission when scheduling downlink and uplink transmission within its COT. The splits between portions available for downlink (DL) and uplink (UL) transmission may be configured in addition to the splits between the first and the second pattern. It is to be noted that the maximum duration of single COT is to be less than or equal to the maximum channel occupancy time.

In some example embodiments, a scheduling node acquires a channel by performing a type 1 LBT and initiates downlink transmission. The scheduling node uses the COT only for downlink transmission. The scheduling node may send resource allocation information indicating to a terminal device or an access node to acquire a separate COT for uplink transmission. The terminal device or the access node then acquires a channel by performing a type 1 LBT and uses COT for uplink transmission. The ending of the COT depends on the uplink scheduling determined by the scheduling node and is confined within the block of portions according to the corresponding pattern.

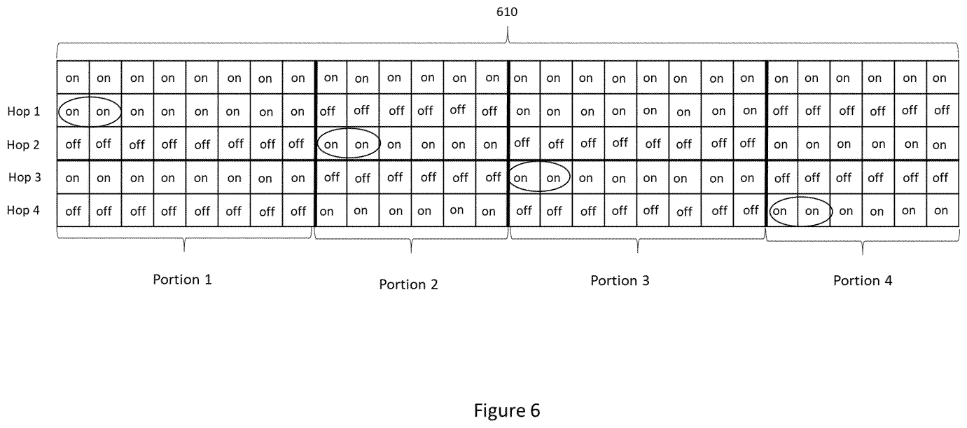

FIG. 6 illustrates an example embodiment in which the first and the second patterns may be dynamically reconfigured. In this example embodiment, the time domain resource partitioning (610) that comprises predefined splits for between the odd and even numbered hops. The first and second patterns define “on” and “off” times for the odd and even numbered hops such that resource are not allocated simultaneously to odd and even numbered hops. In this example embodiment, a donor node with a wired backhaul connection determines that a time domain resource partitioning is to be dynamically re-configured such that the first and the second patterns are modified. The donor node then informs scheduling nodes regarding the dynamic modification. In this example embodiment, there are 4 hops and thereby 4 scheduling nodes need to be informed. Because of the number of hops, the donor node needs to take into account that all the scheduling nodes need to have the information before the dynamic modification is to take place. Therefore, the information regarding the dynamic modification is to comprise the starting time of the modified configuration as well as the modifications to the first and the second pattern. The information may be transmitted using for example a bitmap or an index for a list of higher layer configured patterns. The information may be transmitted using layer 1, L1, control signalling, such as GC-PDCCH, MAC or higher layer signalling such as RRC. In some example embodiments, the scheduling node may acknowledge that it has received the information.

The information regarding the dynamic modifications is propagated in the multi-hop chain. In this example embodiment, there are 4 various portions and in each portion the information has propagated one hop in the multi-hop chain. The information indicating the dynamic modification is illustrated in FIG. 6 by circulating portions of the patterns.

It is to be noted that the example embodiments mentioned above are compatible with any LBT enhancements such as beam domain starting with omni-LBT followed by a single-shot LBT in the beam domain, beam specific type 1 LBT followed by a single-shot omni-direction LBT or type 1 LBT constructed from a combination of beam-specific and omni-directional LBT measurements.

It is also to be noted that in the examples mentioned above, a COT may comprise multiple switching points between portions available for downlink transmission and portions available for uplink transmission, which may provide improved latency performance without increasing overhead of frequent channel access procedures unreasonably. If multiple switching points are used in within a COT, channel access procedures need to take that into account. A scheduling node may then perform type 1 LBT at the beginning of the COT and an IAB node performing uplink transmission to the scheduling node may perform type 2 LBT, or alternatively do not perform any LBT, at the beginning of the portion available for the uplink transmission. In an example with at least two switching points, scheduling node may perform type 2 LBT, or alternatively do not perform any LBT, before the second downlink transmission.

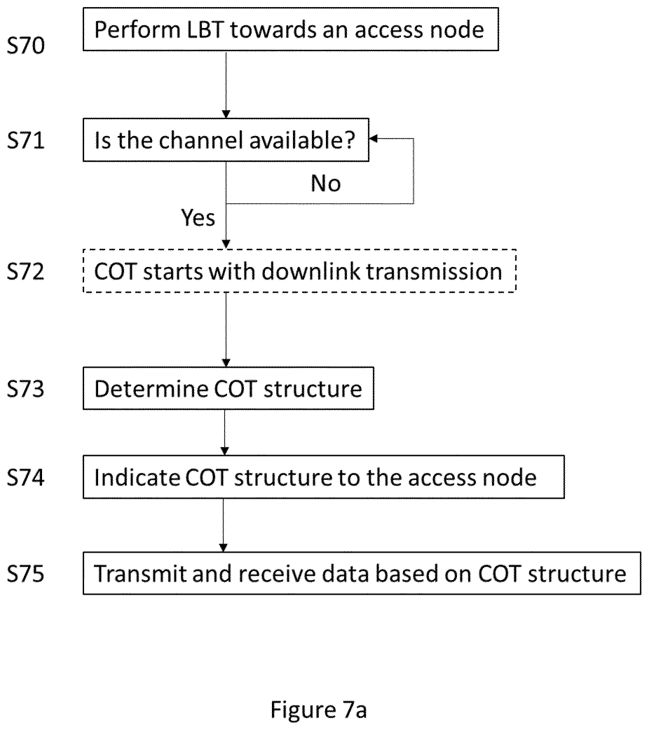

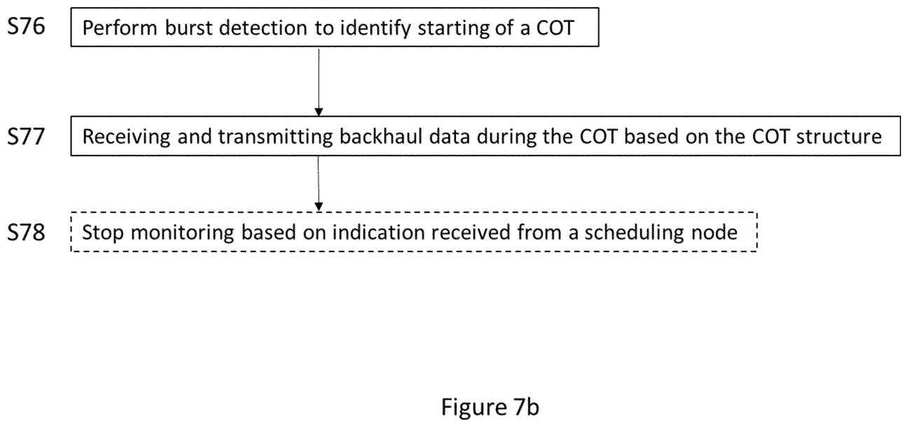

FIG. 7a is a flow chart illustrating an example embodiment of a scheduling node. When the pattern associated with the scheduling node is “on” meaning that resources are available, the scheduling node performs LBT, such as type 1 LBT, towards at least one access node such as an IAB node (S70). If the LBT is not successful, the scheduling node performs self-deferral and performs LBT again later to see if channel is available. If the LBT is successful, the scheduling node acquires the channel and a COT begins (S71). In some example embodiments the COT begins with downlink transmission (S72).

The scheduling node then determines the structure for the COT (S73) covering time contiguous resources confined by a pattern. The COT structure may indicate for example duration of the COT, duration of portion(s) available for downlink transmission, duration of portion(s) available for uplink transmission and number of switch points. The scheduling node may then indicate the COT structure to the access node (74) by using for example GC-PDCCH. Finally the scheduling node transmits and received backhaul data with the access node according to the COT structure (S75).

FIG. 7b is a flow chart illustrating an example embodiment in which backhaul data is received and transmitted by an access node, such as IAB node or by a terminal device. First a burst detection is performed to identify starting of a COT (S76). In some example embodiments, additionally or alternatively PDCCH monitoring may be performed. Then backhaul data is received and transmitted according to the structure of the COT (S77). In some example embodiments, type 2 LBT may be performed before the beginning of the uplink transmission. Finally, in some example embodiments, an indication may be received from a scheduling node to stop monitoring in which case, the monitoring is stopped (S78).

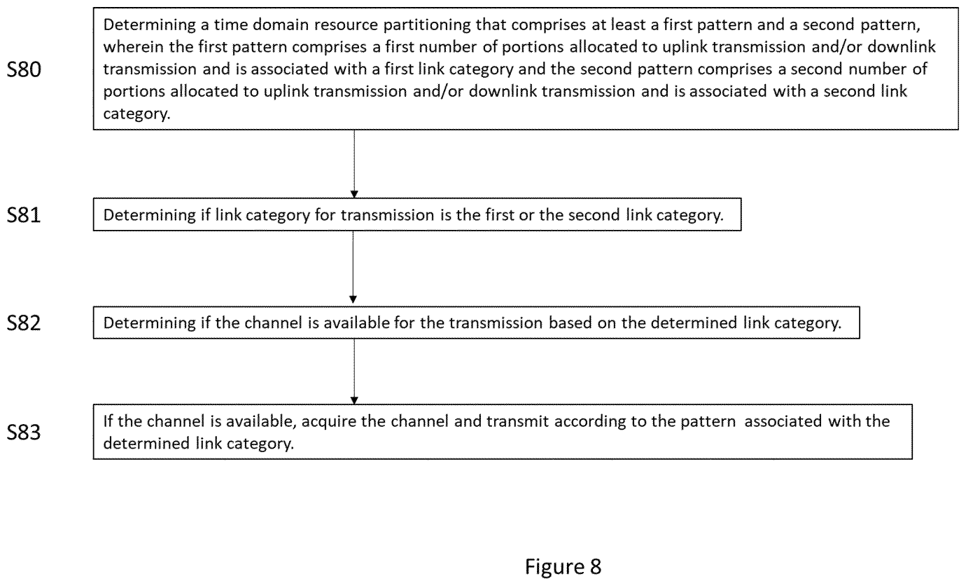

FIG. 8 illustrates yet another example embodiment. First, in step S80, it is determined that a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category. Then in step S87 it is determined if link category for transmission is the first or the second link category. After that in step S 82 it is determined if the channel is available for the transmission based on the determined link category. In step S83, if the channel is available, the channel is acquired and transmitting according to the pattern associated with the determined link category takes place.

The example embodiments discussed above provide various advantages. Some of the advantages include supporting any number of hops, supporting of operation without cross-link interference, supporting both dynamic and semi-dynamic resource partitioning between various links, such as backhaul link, access link, downlink and uplink, and supporting power saving for terminal devices connected to IAB nodes.

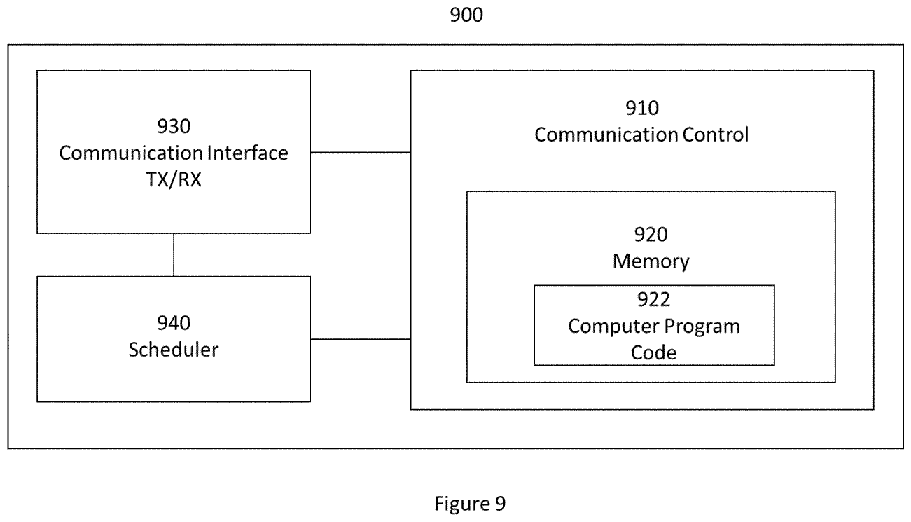

The apparatus 900 of FIG. 9 illustrates an example embodiment of an apparatus that may be an access node or be comprised in an access node. The apparatus may be, for example, a circuitry or a chipset applicable to an access node to realize the described embodiments. The apparatus (900) may be an electronic device comprising one or more electronic circuitries. The apparatus (900) may comprise a communication control circuitry (910) such as at least one processor, and at least one memory (920) including a computer program code (software) (922) wherein the at least one memory and the computer program code (software) (922) are configured, with the at least one processor, to cause the apparatus (900) to carry out any one of the example embodiments of the access node described above.

The memory (920) may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store current neighbour cell list, and, in some example embodiments, structures of the frames used in the detected neighbour cells.

The apparatus (900) may further comprise a communication interface (930) comprising hardware and/or software for realizing communication connectivity according to one or more communication protocols. The communication interface (930) may provide the apparatus with radio communication capabilities to communicate in the cellular communication system. The communication interface may, for example, provide a radio interface to terminal devices. The apparatus (900) may further comprise another interface towards a core network such as the network coordinator apparatus and/or to the access nodes of the cellular communication system. The apparatus (900) may further comprise a scheduler (940) that is configured to allocate resources.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 2 to 8 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-23. (canceled)

24. An apparatus comprising:
at least one processor, and
at least one memory including a computer program code, wherein the at least one memory and the computer program code are configured, with the at least one processor, to cause the apparatus to:
determine a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category;
determine if link category for transmission is the first or the second link category;
determine if the channel is available for the transmission according to a pattern associated with the determined link category, wherein the pattern associated with the determined link category corresponds to the first or the second pattern; and if the channel is available,
acquire the channel and transmit according to the pattern associated with the determined link category.

25. An apparatus according to claim 24, wherein the apparatus indicates to another apparatus, regarding the pattern associated with the determined link category, a duration of one or more portions available for downlink transmission and a duration of one or more portions available for uplink transmission.

26. An apparatus according to claim 24, wherein at least one of the first and the second pattern begins with one or more portions available for downlink transmission.

27. An apparatus according to claim 24, wherein the time domain resource partitioning comprises at least one split between the first and the second link categories.

28. An apparatus according to claim 24, wherein the maximum duration of the consecutive portions associated to the first or second pattern is less than or equal to a maximum channel occupancy time.

29. An apparatus according to claim 24, wherein the first link category is associated with an odd hop count in a multi-hop network and the second link category is associated with an even hop count in the multi-hop network.

30. An apparatus according to claim 24 wherein the apparatus comprises a mobile terminal functionality and the first link category is associated with the mobile terminal functionality, and the apparatus further comprises distributed unit functionality and the second link category is associated with the distributed unit functionality.

31. An apparatus according to claim 24, wherein the apparatus is further configured to dynamically modify the time domain resource partitioning between the first and the second pattern.

32. An apparatus according to claim 31, wherein the dynamic modification is performed based on instructions received from a donor node or from a central unit.

33. An apparatus according to claim 24, wherein the detecting if the channel is available for transmission comprises performing a first type of detection before downlink transmission.

34. An apparatus according to claim 24, wherein the detecting if the channel is available for transmission comprises performing a second type of detection before uplink transmission.

35. An apparatus according to claim 24 wherein the time domain resource partitioning is configured such that portions comprised in the first pattern and available for the first link category are not simultaneous to portions comprised in the second pattern and available for the second link category.

36. An apparatus according to claim 24, wherein determining the time domain resource partitioning further comprises defining and signalling the time domain resource partitioning to the other apparatus.

37. An apparatus according to claim 24 wherein transmitting begins and ends within a block of portions associated with the pattern associated with the determined link category.

38. An apparatus according to claim 25, wherein transmitting begins and ends within the one or more portions available for downlink transmission or within the one or more portions available for uplink transmission.

39. An apparatus according to claim 24, wherein the first pattern and/or the second pattern comprise at least two portions available for downlink transmission and at least one portion available for uplink transmission.

40. An apparatus according to claim 24, wherein if the channel is available for transmission, the apparatus begins downlink transmission if the pattern associated with the determined link category comprises one or more portions available for downlink transmission and if not, the apparatus defers the transmission until there are one or more portions available for the downlink transmission, performs a single-shot listen-before-talk measurement and if the measurement is positive, begins the downlink transmission.

41. An apparatus according to claim 24, wherein determining the time domain resource partitioning further comprises receiving the time domain resource partitioning.

42. A method comprising:
determining a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category;
determining if link category for transmission is the first or the second link category;
determining if the channel is available for the transmission according to a pattern associated with the determined link category, wherein the pattern associated with the determined link category corresponds to the first or the second pattern; and if the channel is available,
acquiring the channel and transmit according to the pattern associated with the determined link category.

43. A non-transitory computer readable medium storing a program of instructions, execution of which by a processor configures an apparatus to at least:
determining a time domain resource partitioning that comprises at least a first pattern and a second pattern, wherein the first pattern comprises a first number of portions allocated to uplink transmission and/or downlink transmission and is associated with a first link category and the second pattern comprises a second number of portions allocated to uplink transmission and/or downlink transmission and is associated with a second link category;
determining if link category for transmission is the first or the second link category;
determining if the channel is available for the transmission according to a pattern associated with the determined link category, wherein the pattern associated with the determined link category corresponds to the first or the second pattern; and if the channel is available,
acquiring the channel and transmit according to the pattern associated with the determined link category.
